(19) United States
(12) Patent Application Publication
(10) Pub. No.: US 2023/0146573 A1
(43) Pub. Date: May 11, 2023

(54) POWDER SHERARDIZING AGENT, ANTI-CORROSION METAL PART, AND SHERARDIZING METHOD

(71) Applicant: YANCHENG KEAO MACHINERY CO., LTD, Yancheng City (CN)

(72) Inventors: Linjiang YUE, Yancheng City (CN); Wei SHEN, Yancheng City (CN); Zheng YUE, Yancheng City (CN)

(21) Appl. No.: 17/599,748

(22) PCT Filed: Sep. 8, 2020
(86) PCT No.: PCT/CN2020/113896

§ 371 Date: Sep. 29, 2021

(30) Foreign Application Priority Data
Jul. 31, 2020 (CN) 202010760694.4

(51) Int. Cl. C23C 10/52

(52) U.S. Cl. CPC C23C 10/52

(57) ABSTRACT

The disclosure provides a powder sherardizing agent, anti-corrosion metal part and sherardizing method. The powder sherardizing agent in parts by mass includes 20-100 parts of a metal powder, 40-80 parts of a dispersing agent, 0.2-5 parts of decomposing agent. The metal powder includes 60-97 parts of zinc powder and 3-40 parts of magnesium powder. The powder sherardizing agent provided by this disclosure can realize the infiltration of magnesium during the sherardizing process. Zinc and magnesium can form a zinc-magnesium alloy phase with high corrosion resistance, thereby greatly improving the corrosion resistance of the infiltration layer. The sherardizing method provided by this disclosure has the advantages of simple operation, convenient use, low cost, high economic benefit, and wide application range.

### TECHNICAL FIELD

The disclosure relates to the technical field of surface chemical heat treatment of metal materials, in particular to a powder sherardizing agent, an anti-corrosion metal part, and a sherardizing method.

### BACKGROUND

Sherardizing is a chemical heat treatment process in which zinc is infiltrated into the surface of metal material. The sherardizing treatment on the surface of metal material can significantly improve its resistance to atmospheric corrosion. Powder sherardizing has a series of advantages such as no hydrogen embrittlement, high bonding strength, and good corrosion resistance, and can be widely applied in the anti-corrosion treatment for the surface of the metal part. At present, in the world, powder sherardizing for anti-corrosion treatment is used in most railway fasteners, high-strength fasteners and the like for the surface protection.

However, the existing powder sherardizing technology has the defect of low corrosion resistance. When the metal part is subjected with the powder sherardizing by the powder sherardizing agent, an infiltration layer will be formed on the metal part. When the sherardizing is performed by using the powder sherardizing agent currently sold on the market, the formed infiltration layer mainly includes the zinc-iron alloy phase and the zinc phase. Zinc has an anisotropic close-packed hexagonal crystal structure, and the lattice constants are represented by a and c. During the sherardizing process, zinc grows oriented and will preferentially grow along the c-axis direction. The self-diffusion coefficient of zinc along a direction parallel to the c-axis direction is nearly 20 times that along a direction perpendicular to the c-axis direction. However, due to the anisotropy, the grain boundaries between the zinc crystals during the growth process have a weak grain boundary structure. During the corrosion process, this weak grain boundary structure is transparent to corrosive substances such as chloride ions. Therefore, the corrosive substances can directly penetrate the grain boundary of zinc and enter the steel matrix, resulting in red rust spots on the surface of the infiltration layer soon. In the salt spray performance test, the time when red rust appears on the surface is generally determined as the life of the salt spray corrosion resistance. Generally, the life of the salt spray corrosion resistance of common infiltration layer may be only tens of hours, which is far from meeting the requirements of the life of salt spray life in engineering that is about hundreds or even thousands of hours. Therefore, it is required to perform surface sealing and dacromet coating after the powder sherardizing, to improve its overall corrosion resistance. However, surface sealing and dacromet relate to organic or inorganic coatings. Under the conditions such as sandstorm, erosion in the actual use environment, the sealing layer would be easily worn away. Therefore, the premature corrosion will occur, causing premature failure of the metal part.

At present, the existing technologies used for improving the corrosion resistance of the sherardized layer are mainly achieved by adding aluminum, nickel, or rare earth element. However, in practical applications, these existing methods are still limited in improving the corrosion resistance of the sherardized layer. The patent application entitled with “Anti-corrosion process to ferrous metal with zinc-nickel infiltration layer” discloses a composition of the zinc-nickel infiltration layer and a powder infiltration process in which the content of nickel powder is 0.5 wt %-1.4 wt %. However, it is difficult to form the infiltration layer by infiltrating nickel when performing powder infiltration treatment below 500° C., and thus it is difficult to form the infiltration layer with high corrosion resistance. The corrosion resistance obtained thereby is basically equivalent to that obtained by traditional powder sherardizing, thereby not achieving the effect of improving the corrosion resistance of the infiltration layer.

Magnesium has very active chemical properties, can react with many non-metallic substances such as O₂, N₂, H₂O, and it is very difficult to control the using amount of magnesium. Due to the special chemical properties of magnesium, magnesium powder is rarely added to the powder sherardizing agent in the related art, even if the magnesium powder is included in the powder sherardizing agent at a very low content and usually needs to be used in conjunction with a variety of other ingredients, rather than playing a major role. For example, the patent application entitled “powder sherardizing agent with high-activity and fast-infiltration” discloses a powder sherardizing agent with high-activity and fast-infiltration in which aluminum and magnesium are added for increasing the activity of the sherardizing agent, and in turn for achieving rapid infiltration. However, it fails to achieve the effect of improving the corrosion resistance of the infiltration layer. In addition, the magnesium powder added to the existing powder sherardizing agent usually has a particle size below 10 μm, and the content of the magnesium powder of the metal powder is often less than 5%. Mostly, adding magnesium powder to the existing powder sherardizing agent is used for cleaning the surface of the metal part through the high-temperature reaction of the magnesium powder, which can be achieved by magnesium powder with above-mentioned particle size and content. However, although magnesium powder with the particle size of less than 10 μm can play a role in cleaning the surface, it is prone to explosion, has low safety, and can react to form gaseous compounds under high temperature conditions. In addition, when the content of magnesium powder of the metal powder is less than 5%, almost all of the magnesium powder would react with the metal surface under high temperature conditions, so that it cannot or rarely enter the infiltration layer.

Therefore, there are still problems whether magnesium is useful in the powder sherardizing agent, whether it can play a positive role in the powder sherardizing agent, and whether the addition of magnesium can bring unexpected effects to the powder sherardizing agent.

### SUMMARY

In view of the above, embodiments of the disclosure provide a powder sherardizing agent, an anti-corrosion metal part, and a sherardizing method, so as to solve the technical defects in the related art.

The disclosure provides a powder sherardizing agent. The powder sherardizing agent includes in parts by mass, 20-100 parts of a metal powder, 40-80 parts of a dispersing agent, and 0.2-5 parts of a decomposing agent. The metal powder includes 60-97 parts of zinc powder and 3-40 parts of magnesium powder.

Preferably, a mass part of the metal powder is 40-80 parts. More preferably, the mass part of the metal powder is 50-70 parts, such as 55 parts, 60 parts, 65 parts, etc.

In the metal powder, a mass part of the zinc powder is preferably 70-90 parts, more preferably 75-85 parts, such as 77 parts, 80 parts, 83 parts, etc. A mass part of the magnesium powder is preferably 5-38 parts, more preferably 10-35 parts, such as 15 parts, 20 parts, 25 parts, 30 parts, etc.

When the metal part is subjected with the sherardizing by the powder sherardizing agent, a certain amount of magnesium would be accumulated at the weak grain boundaries of zinc, and thus, through high-temperature reaction, form zinc-magnesium alloy phases such as MgZn₂, Mg₂Zn₁₁ with high corrosion resistance. Therefore, this promotes the transformation of the weak grain boundary structure into a strong grain boundary structure that can effectively block the corrosive substances such as chloride ions, thereby greatly improving the corrosion resistance of the infiltration layer.

Further, the magnesium powder is pure magnesium powder or magnesium alloy powder. The magnesium powder is preferably pure magnesium powder with purity greater than 95% or the magnesium alloy powder with a weight ratio of not less than 40% magnesium.

Further, the dispersing agent is ceramic powder, which can effectively prevent metal powder from bonding. The decomposing agent is ammonia halide, which can decompose to provide ammonia and hydrogen halide gas, which can not only clean the surface of the metal part, but also activate other components to help the sherardizing process.

Further, the ceramic powder includes at least one of aluminum oxide, silicon oxide, magnesium oxide, aluminum nitride, silicon nitride, and silicon carbide. The decomposing agent is ammonium halide, and the ammonium halide includes at least one of ammonium chloride, ammonium fluoride, ammonium iodide, ammonium bromide, and ammonium hydrogen fluoride.

Further, the powder sherardizing agent further includes 0.5-3 parts of an active agent capable of promoting infiltration of magnesium into an infiltration layer.

Further, the active agent is a magnesium halide. The magnesium halide can promote the interaction between magnesium and zinc, and thus promote the accumulation of magnesium at the zinc grain boundary, thereby further improving the corrosion resistance of the infiltration layer.

Further, the magnesium halide includes at least one of magnesium chloride, magnesium fluoride, magnesium iodide, and magnesium bromide.

Further, the magnesium powder has a particle size of 10 μm-500 μm, the zinc powder has a particle size of 1 μm-200 μm, and the dispersing agent has a particle size of 5 μm-500 μm.

Further, the powder sherardizing agent further includes manganese dioxide, and a mass part of manganese dioxide is not greater than a mass part of the decomposing agent. Manganese dioxide can promote the diffusion of magnesium into the infiltration layer during the sherardizing process, thereby promoting more magnesium and zinc to react to form a zinc-magnesium alloy phase with high corrosion-resistance, and improving the corrosion resistance of the infiltration layer.

The disclosure also provides an anti-corrosion metal part having an infiltration layer formed by a surface of the anti-corrosion metal part through magnesium and zinc infiltrated by the powder sherardizing agent as described above, and capable of preventing the corrosion of the metal part.

Further, the infiltration layer has an average content of magnesium of 0.5 wt %-20 wt %. When the magnesium content of the infiltration layer is within this range, its corrosion resistance is the strongest. If the content is too low, magnesium will mainly react with oxygen in the oxygen-containing substance and cannot enter the infiltration layer. If the magnesium content is too high, it will result in the formation of more magnesium alloy that is not resistant to corrosion. Therefore, it will lead to the reduction of the corrosion resistance.

Further, the infiltration layer has a thickness of 5 μm-200 μm.

The disclosure also provides a sherardizing method including the following operations.

S1, a metal part to be sherardized is treated with degreasing and derusting. The treated metal part and the powder sherardizing agent described above are placed in a closed infiltration tank.

S2, air is driven out from the closed infiltration tank, and a valve of the closed infiltration tank is closed.

S3, a temperature of the closed infiltration tank is raised. After reaching a preset temperature, the temperature is kept for 1-10 hours to complete the sherardizing.

Further, S2 includes the following operations.

The closed infiltration tank is evacuated, or a protective atmosphere is introduced into the closed infiltration tank to drive out the air from the closed infiltration tank and close the valve of the closed infiltration tank.

Further, S3 includes the following operations.

The temperature of the closed infiltration tank is raised, and the temperature is reached to 360° C.-415° C. or 320° C.-480° C. for 1-10 hours to complete the sherardizing.

The powder sherardizing agent provided in this disclosure includes the metal powder, the dispersing agent, and the decomposing agent. The metal powder includes zinc powder and magnesium powder. Due to the anisotropy, the grain boundaries between the zinc crystals during the growth process have a weak grain boundary structure. This weak grain boundary structure is transparent to corrosive substances such as chloride ions. Therefore, the corrosive substances can directly penetrate the grain boundary of zinc, resulting in corrosion. Magnesium can accumulate at the weak grain boundary structure of zinc. Through high-temperature reaction, zinc-magnesium alloy phases such as MgZn₂, Mg₂Zn₁₁ with high corrosion resistance can be formed. Therefore, this promotes the transformation of the weak grain boundary structure into a strong grain boundary structure that can effectively block the corrosive substances such as chloride ions, thereby greatly improving the corrosion resistance of the infiltration layer.

As for the powder sherardizing agent provided in this disclosure, the mass part of magnesium powder is 3-40 parts, so that the average content of magnesium in the infiltration layer can be guaranteed to be between 0.5 wt %-20 wt %, ensuring that the corrosion resistance of the infiltration layer can be maximized. Upon lots of tests, it is proved when the magnesium content in the infiltration layer is less than 0.5 wt % (i.e., when the mass part of the magnesium powder is less than 3 parts), magnesium will mainly react with oxygen in the oxygen-containing substance and cannot enter the infiltration layer; if the magnesium content in the infiltration layer is greater than 20 wt % (i.e., when the mass part of the magnesium powder is greater than 40 parts), the magnesium content in the infiltration layer will be too high, which will result in the formation of more magnesium alloy that is not resistant to corrosion. Therefore, it will lead to the reduction of the corrosion resistance. Compared with the common infiltration layer, the infiltration layer containing 0.5 wt %-20 wt % magnesium has dozens of times longer neutral salt spray resistance life, and thus has extremely high engineering application value and application prospects.

In addition, the powder sherardizing agent provided in the disclosure may also include the active agent. The active agent is preferably a magnesium halide. The magnesium halide can promote the interaction between magnesium and zinc, and thus promote the accumulation of magnesium at the zinc grain boundary, thereby further improving the corrosion resistance of the infiltration layer.

As for the anti-corrosion metal part provided by the disclosure, zinc and magnesium are infiltrated into the surface of the metal part through the above powder sherardizing agent to form the infiltration layer that can prevent corrosion of the metal part. Magnesium interacts with zinc to form a zinc-magnesium alloy phase with high corrosion resistance such as MgZn₂ and Mg₂Zn₁₁, building a solid protective barrier for the metal part, blocking the corrosion of metal parts by corrosive substances such as chloride ions, effectively improving the corrosion resistance of the metal part, prolonging the service life of the metal part with low cost and convenient application.

The sherardizing method provided by the disclosure, can effectively prevent magnesium of the powder sherardizing agent from reacting with air by driving out the air from the closed infiltration tank. By raising the temperature of the closed infiltration tank, not only the air in the closed infiltration tank is further driven away, but also suitable environmental conditions are created to complete the sherardizing of the metal part. After the temperature is raised to the preset temperature, the temperature is kept for 1-10 hours to complete the sherardizing. Through this method, the sherardizing achieves good effects, and the infiltration layer has high quality. The sherardizing method provided by the disclosure has advantages such as simple operation, convenient use, low cost, high economic benefit, and wide application range.

### BRIEF DESCRIPTION OF THE DRAWINGS

FIG. 1 shows the composition distribution of a magnesium-containing sherardized layer with an average magnesium content of 5 wt % on the steel surface according to an example of the disclosure.

FIG. 2 shows the comparison of X-ray diffraction (XRD) phase structures obtained from three infiltration layers with different magnesium contents.

FIG. 3 shows surface states of a magnesium-containing sherardized layer in salt spray corrosion at different time points according to an example of the disclosure.

FIG. 4 shows the cross-section state of a magnesium-containing sherardized layer in salt spray corrosion for 0 hours according to an example of the disclosure.

FIG. 5 shows the cross-section state of a magnesium-containing sherardized layer in salt spray corrosion for 1000 hours according to an example of the disclosure.

FIG. 6 shows the cross-section state of a magnesium-containing sherardized layer in salt spray corrosion for 2000 hours according to an example of the disclosure.

FIG. 7 shows the cross-section state of a magnesium-containing sherardized layer in salt spray corrosion for 4000 hours according to an example of the disclosure.

FIG. 8 shows a surface of the infiltration layer with an average magnesium content of 43% according to an example of the disclosure.

FIG. 9 shows the cross-section topography of the infiltration layer with an average magnesium content of 43% according to an example of the disclosure.

FIG. 10 is an enlarged view of corrosion products on the surface of common sherardized layer according to an example of the disclosure

FIG. 11 is an enlarged view of corrosion products on the surface of a magnesium-containing sherardized layer of an anti-corrosion metal part according to an example of the disclosure.

FIG. 12 shows the comparison of the results of a salt spray test of a metal part according to an example of the disclosure.

### DETAILED DESCRIPTION

Hereafter, the examples of the present disclosure will be described in combination with the accompanying drawings.

In the present disclosure, unless otherwise specified, the scientific and technical terms used herein have the meanings commonly understood by those skilled in the art. In addition, reagents, materials, and operation used herein are all those widely used in the corresponding field.

### EXAMPLE 1

This example provides a powder sherardizing agent. The powder sherardizing agent includes in parts by mass, 20-100 parts of a metal powder, 40-80 parts of a dispersing agent, and 0.2-5 parts of a decomposing agent. The metal powder includes 60-97 parts of zinc powder and 3-40 parts of magnesium powder.

On the one hand, the atomic radius of zinc is 0.1332 nanometers, and the atomic radius of magnesium is 0.1598 nanometers. The difference between the atomic radii of zinc and magnesium is less than 15%. In addition, both magnesium and zinc have a close-packed hexagonal structure, and thus can work together to form an infiltration layer. Although magnesium itself is not resistant to corrosion, it can occupy part of the position of zinc atoms in the crystal structure of zinc, especially at the grain boundaries. A certain amount of magnesium may accumulate at the weak grain boundaries of zinc and form through high-temperature reactions, zinc-magnesium alloy phases such as MgZn₂, Mg₂Zn₁₁. The zinc-magnesium alloy phases such as MgZn₂, Mg₂Zn₁₁ have high corrosion-resistance, and therefore, the formation of these phases at the grain boundaries can promote the original weak grain boundary structure to become a strong grain boundary structure. Especially, such strong grain boundary structure is not transparent to corrosive substances such as chloride ions, and thus can block these corrosive substances. Meanwhile, during the corrosion process of zinc-magnesium alloy phases such as MgZn₂, Mg₂Zn₁₁, the corrosion products caused thereby have a dense structure, rather than the loose structure caused by ordinary powder sherardizing, which greatly improves the corrosion resistance of the metal part and greatly extends the service life of the metal part.

On the other hand, in the powder sherardizing agent, the mass part of magnesium powder being 3-40 parts can ensure that 0.5 wt %-20 wt % of magnesium can be blended into the infiltration layer, thereby promoting the formation of high corrosion resistant alloy phase such as MgZn₂, Mg₂Zn₁₁, and greatly improving the life of the corrosion resistance of the metal part. Because magnesium itself is extremely active, magnesium will preferentially react with oxygen of oxygen-containing substances, such as oxygen in the air, oxygen in iron oxides, oxygen in zinc oxides, etc. Once a certain amount of oxide is formed on the surface of magnesium, it is difficult for magnesium to diffuse into the metal matrix.

Lots of experimental data show that, compared with the infiltration layer formed by common powder sherardizing agent, the infiltration layer containing 0.5 wt %-20 wt % magnesium has dozens of times longer neutral salt spray resistance life, and thus has extremely high engineering application value and application prospects.

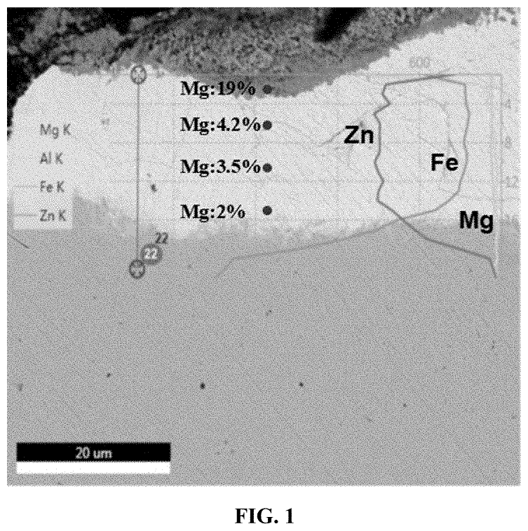

Referring to FIG. 1, it shows the composition distribution of a magnesium-containing sherardized layer with an average magnesium content of 5 wt % on the steel surface. As can be seen from this figure, the average content of magnesium is 19% at 0-4 μm, the average content of magnesium is 4.2% at 4-8 μm, the average content of magnesium is 3.5% at 8-12 μm, and the average content of magnesium is 2% at 12-16 μm. That is, the magnesium content of the infiltration layer gradually increases from the inside to the outside. This is because zinc first diffuses to the surface of the steel part and forms a zinc-iron alloy layer with iron, and then magnesium diffuses into zinc. Therefore, from inside to outside, the higher the zinc content is, the less iron content is. In addition, the corresponding magnesium content is increased with the zinc content. The life of the salt spray resistance of the infiltration layer can reach 4000 hours.

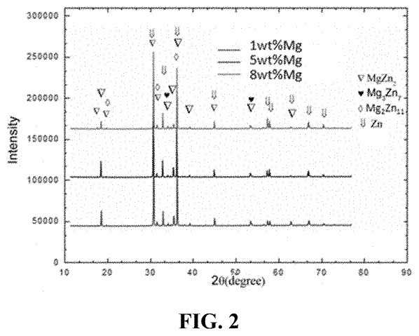

Referring to FIG. 2, it shows the comparison of X-ray diffraction (XRD) phase structures obtained from three infiltration layers with different magnesium contents. It can be seen that no matter the magnesium content of the cemented layer is 1 wt %, 5 wt % or 8 wt %, they all have high corrosion-resistant zinc-magnesium alloy phases such as MgZn₂, Mg₂Zn₁₁.

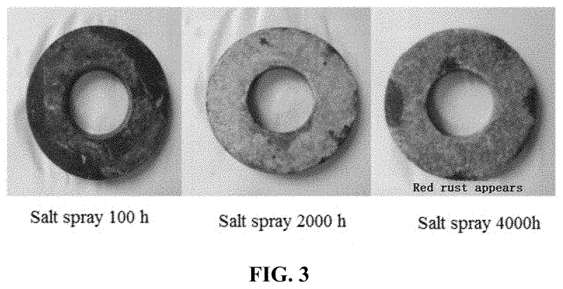

We have analyzed the life of the steel part with the average magnesium content of 5 wt % in salt spray test. The test is based on GB/T10125-2012, and the results obtained thereby are shown in FIG. 3. FIG. 3 shows surface states of the steel in salt spray test corrosion for 100 hours, 2000 hours, and 4000 hours. It can be seen from FIG. 3 that no red rust appears on the surface of the steel part under the conditions of 100 hours and 2000 hours of salt spray, and red rust appears on the surface of the steel part under the condition of 4000 hours of salt spray.

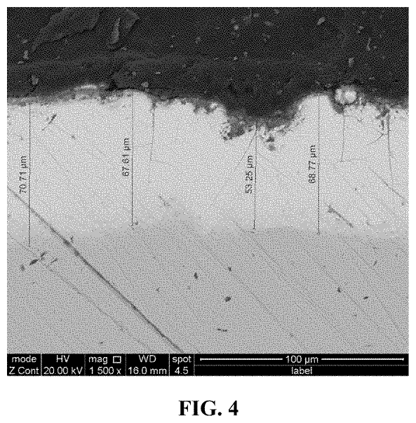

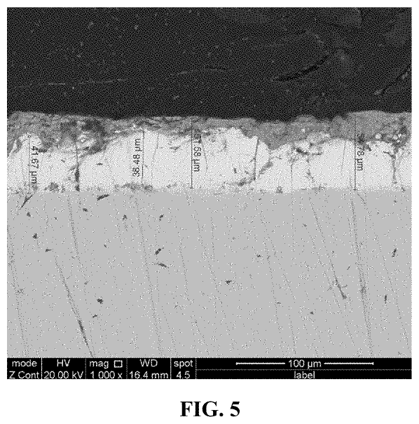

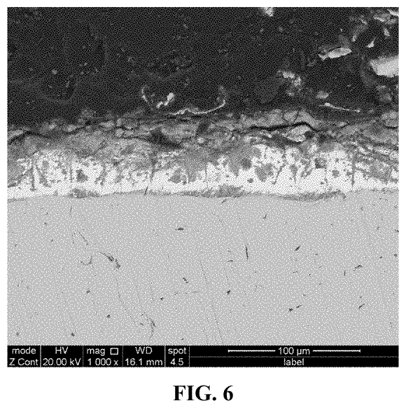

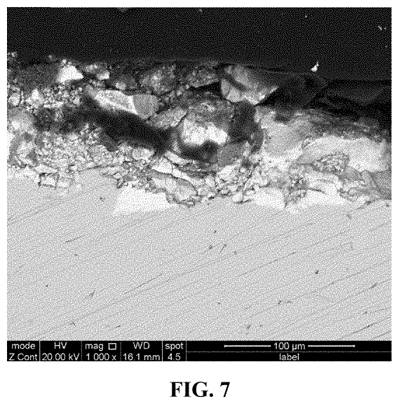

Referring to FIGS. 4-7, they respectively show the cross-section state of a magnesium-containing sherardized layer in salt spray corrosion for 100 hours, 2000 hours, and 4000 hours of salt spray. It can be seen that the thickness of the infiltration layer gradually decreases over time. In the case of 4000 hours of salt spray, the steel part will be corroded. It can be seen that adding an appropriate amount of magnesium to the powder sherardizing agent can greatly improve the resistance of the infiltration layer to the neutral salt spray.

If the content is too low, magnesium will mainly react with oxygen in the oxygen-containing substance and cannot enter the infiltration layer. Because magnesium cannot directly react with metals (such as iron), only the diffusion of zinc to the metal part occurs at the initial stage of the reaction. When the concentration of zinc in the infiltration layer reaches a certain level, magnesium will diffuse into zinc, thus forming magnesium-containing sherardized layer. Especially, when the magnesium content of the powder sherardizing agent is less than 2 wt %, magnesium will react with oxide film on the surface of the metal part and the oxide film the surface of zinc to increase the reaction activity, as it will not directly infiltrate into the metal part at the initial stage of the reaction. When the content of zinc of the infiltration layer reaches the condition that magnesium can be infiltrated, it is not possible to provide enough active magnesium atoms due to the low content and thus to infiltrate into the infiltration layer, as it has been almost consumed by the initial reaction. If the content is too high, it will lead to the formation of more magnesium alloys. The corrosion resistance of the infiltration layer will decrease because the magnesium alloys has poor corrosion resistance. Moreover, due to the extremely activity of magnesium, too high content can cause an explosion, leading to low safety.

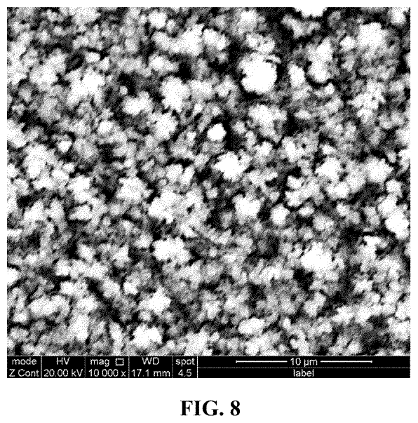

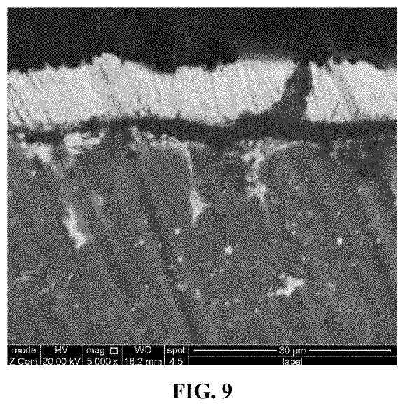

Referring to FIG. 8 and FIG. 9, FIG. 8 shows a surface of the infiltration layer with an average magnesium content of 32%, and FIG. 9 shows the cross-section topography of the infiltration layer with an average magnesium content of 32%. From the surface, a large amount of loose structure is formed on the surface of the infiltration layer, which is mainly constructed by magnesium alloy. From the cross-section, when the magnesium content is too high, there is a cracking phenomenon in the infiltration layer. The corrosive substances will directly enter the matrix through the cracks. Therefore, if the magnesium content is too high, the corrosion resistance of the infiltration layer will be decreased.

In addition, the magnesium powder may be pure magnesium powder with purity greater than 95%, or the magnesium alloy powder with a weight ratio of not less than 40% magnesium, so as to provide a sufficient magnesium atom for infiltrating into the infiltration layer.

In this example, the mass part of the metal powder may be 20 parts, 25 parts, 30 parts, 35 parts, 40 parts, 45 parts, 50 parts, 55 parts, 60 parts, 65 parts, 70 parts, 75 parts, 80 parts, 85 parts, 90 parts, 95 parts, 100 parts, or the like, preferably 40-80 parts, more preferably 50-70 parts. The mass part of zinc powder of the metal powder may be 60 parts, 65 parts, 70 parts, 75 parts, 80 parts, 85 parts, 90 parts, 95 parts, or the like, preferably 70-90 parts, more preferably 75-85 parts. The zinc powder may preferably have a particle size of 1 μm-200 μm, may be 1 μm, 10 μm, 30 μm, 50 μm, 100 μm, 150 μm, 200 μm or the like. The mass part of the magnesium powder may be 3 parts, 5 parts, 10 parts, 15 parts, 20 parts, 25 parts, 30 parts, 35 parts, 40 parts, or the like, preferably 8-38 parts, more preferably 10-35 parts. The magnesium powder may preferably have a particle size of 10 μm-500 μm, and may be 1 μm, 10 μm, 30 μm, 50 μm, 100 μm, 150 μm, 200 μm, 250 μm, 300 μm, 350 μm, 400 μm, 450 μm, 500 μm, or the like. The above parameters can be determined according to specific circumstances, which is not limited in this disclosure. It should be noted that if the particle size of the magnesium powder is less than 10 μm, the magnesium powder is extremely explosive and its safety is extremely low. If the particle size of the magnesium powder is greater than 500 μm, its activity and infiltrating rate will decrease rapidly. Therefore, in this example, the particle size of magnesium powder is not arbitrarily limited. Only when the particle size of the magnesium powder is in the range of 10 μm-500 μm, the effect obtained thereby will be most stable.

Specifically, the dispersing agent is preferably ceramic powder, and the ceramic powder includes at least one of aluminum oxide, silicon oxide, magnesium oxide, aluminum nitride, silicon nitride, and silicon carbide. In this example, adding ceramic powder to the powder sherardizing agent can effectively prevent the metal powder from bonding.

In this example, the particle size of the dispersing agent may be preferably 5 μm-500 μm, and specifically may be 5 μm, 10 μm, 50 μm, 100 μm, 150 μm, 200 μm, 250 μm, 300 μm, 350 μm, 400 μm, 450 μm, 500 μm or the like. The mass part of the dispersing agent may be 40 parts, 45 parts, 50 parts, 55 parts, 60 parts, 65 parts, 70 parts, 75 parts, 80 parts, or the like, depending on the specific circumstances, which is not limited herein.

Specifically, the decomposing agent may be preferably ammonium halide. The ammonium halide includes at least one of ammonium chloride, ammonium fluoride, ammonium iodide, ammonium bromide, and ammonium hydrogen fluoride, and is preferably ammonium chloride. Under the temperature conditions of powder sherardizing, the ammonia halide can be decomposed to provide ammonia and hydrogen halide gas, which can be used for cleaning the surface of the metal part, active other components and promote sherardizing. The mass part of the decomposing agent may be 0.2 parts, 0.5 parts, 1 part, 1.5 parts, 2 parts, 2.5 parts, 3 parts, 3.5 parts, 4 parts, 4.5 parts, 5 parts, or the like.

In summary, the powder sherardizing agent provided in this example includes the metal powder, the dispersing agent, and the decomposing agent. The metal powder includes zinc powder and magnesium powder, so that the infiltration of magnesium can be achieved during the sherardizing process. Zinc and magnesium can form the zinc-magnesium alloy phase with high corrosion resistance, which can greatly improve the corrosion resistance of the infiltration layer.

### EXAMPLE 2

On the basis of example 1, this example provides a powder sherardizing agent. The powder sherardizing agent further includes 0.5-3 parts of active agent capable of promoting infiltration of magnesium into an infiltration layer, The mass part of the active agent may be such as 0.5 parts, 1 part, 1.5 parts, 2 parts, 2.5 parts, 3 parts or the like, which is not limited herein.

Specifically, the active agent is preferably magnesium halide, and the magnesium halide includes at least one of magnesium chloride, magnesium fluoride, magnesium iodide, and magnesium bromide.

The magnesium halide is always in a solid state during the powder sherardizing process. Therefore, it can fully contact and react with the surface of the steel part and the infiltration layer, which promotes the infiltration of magnesium. In addition, the magnesium halide is added as the active agent, which can promote the rapid and effective infiltration of magnesium into the infiltration layer, can promote the interaction between magnesium and zinc, and can promote the accumulation of magnesium at the grain boundaries of zinc, thereby effectively improving the corrosion resistance of the infiltration layer. Although ammonium halides such as ammonium chloride and ammonium fluoride also have the effect of activating and promoting infiltration, their effect on the activation and infiltration of magnesium is not significant. Taking ammonium chloride as an example, ammonia and hydrogen chloride are generated by the decomposition of ammonium chloride via heating. Most of the active magnesium atoms generated by the reaction of magnesium and gaseous hydrogen chloride will not attach to the surface of the infiltration layer and react with the infiltration layer.

In summary, the powder sherardizing agent provided in this example includes the metal powder, the dispersing agent, the decomposing agent, and the active agent. The metal powder includes zinc powder and magnesium powder. In this way, the infiltration of magnesium can be achieved during the sherardizing process. Zinc and magnesium will form a zinc-magnesium alloy phase with high corrosion resistance, which can greatly improve the corrosion resistance of the infiltration layer. The addition of the active agent can further promote the infiltration of magnesium powder into the infiltration layer, thereby further improving the performance of the powder sherardizing agent.

### EXAMPLE 3

On the basis of example 1 or example 2, this example provides a powder sherardizing agent. The powder sherardizing agent further includes manganese dioxide. The mass part of manganese dioxide is not greater than the mass part of the decomposing agent. Specifically, the mass part of manganese dioxide can be 0-3 parts, such as 0.01 parts, 0.05 parts, 0.1 parts, 0.2 parts, 0.3 parts, 0.4 parts, 0.5 parts, 1 part, 1.5 parts, 2 parts, 2.5 parts, 3 parts, or the like, depending on the specific circumstances, which is not limited herein.

In the practices, manganese dioxide added to the powder sherardizing agent can be used as a catalyst for the infiltration reaction of magnesium, which promotes the diffusion of magnesium into the infiltration layer by reacting with ammonia halide as the decomposing agent. First, ammonia and hydrogen halide gas are generated by high-temperature decomposition of ammonia halide gas, and then the hydrogen halide gas reacts with manganese dioxide to obtain gases manganese halide and gas such as chlorine gas. Gases such as chlorine gas can provide a large amount of active ions, and the reaction of active ions with magnesium will generate active anhydrous magnesium halide gas. Finally, the active anhydrous magnesium halide gas undergoes a displacement reaction with zinc of the infiltration layer, promoting the diffusion of magnesium into the sherardized layer.

Take ammonium chloride as an example, under a temperature of 350° C., ammonium chloride begins to decompose to produce ammonia and hydrogen chloride. Hydrogen chloride then reacts with manganese dioxide to generate manganese chloride and chlorine gas. Chlorine gas can provide a large amount of active chloride ions on the surface of the infiltration layer. The active chloride ions react with magnesium to generate active anhydrous magnesium chloride gas, and the active anhydrous magnesium chloride gas undergoes a displacement reaction with zinc of the infiltration layer, promoting the diffusion of magnesium into the sherardized layer.

Especially, when the powder sherardizing agent also includes magnesium halide activator, the magnesium halide in the solid state can have double infiltration effects on the gaseous magnesium halide, to promote the continuous infiltration of magnesium into the sherardized layer. Therefore, the sherardized layer would have magnesium that is sufficient to react with zinc to form a zinc-magnesium alloy phase with high corrosion-resistance, improving the corrosion resistance of the infiltration layer.

### EXAMPLE 4

This example provides an anti-corrosion metal part having an infiltration layer formed by a surface of the anti-corrosion metal part through magnesium and zinc infiltrated by the powder sherardizing agent of any one of examples 1-3, and capable of preventing the corrosion of the metal part.

The treated metal part and powder sherardizing agent are placed into a sealed container. ted to a temperature below the melting point of zinc (419.4° C.). The temperature is kept for a certain period of time. The furnace is cooled to room temperature, while an infiltration layer is formed on the surface of the metal part for preventing it from corrosion.

The average content of magnesium in the infiltration layer is between 0.5 wt % and 20 wt %, such as 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt % or the like, to ensure that the corrosion resistance of the infiltration layer can be maximized. Upon lots of tests, it is proved that when the magnesium content of the infiltration layer is less than 0.5 wt % (i.e., when the mass part of the magnesium powder is less than 3 parts), magnesium will mainly react with oxygen in the oxygen-containing substance and cannot enter the infiltration layer; if the magnesium content of the infiltration layer is greater than 12 wt % (i.e., when the mass part of the magnesium powder is greater than 40 parts), the magnesium content in the infiltration layer will be too high, which will result in the formation of more magnesium alloy that is extremely non-corrosion resistance. Therefore, it will lead to the reduction of the corrosion resistance. Compared with the ordinary infiltration layer, the infiltration layer containing 0.5 wt %-20 wt % magnesium has dozens of times longer neutral salt spray resistance life, and thus has extremely high engineering application value and application prospects.

The thickness of the infiltration layer is preferably 20-100 μm, and it may specifically be 20 μm, 30 μm, 40 μm, 50 μm, 60 μm, 70 μm, 80 μm, 90 μm, 100 μm or the like, depending on the specific circumstances, which is not limited herein.

The magnesium content in the infiltration layer decreases with the increase in the depth of the infiltration layer. The magnesium content is higher at the shallower position in the infiltration layer, while the magnesium content is less at the deeper position in the infiltration layer.

In addition, it should be noted that the magnesium content at the surface of the infiltration layer may be greater than 20%, because excessive magnesium powder may attach to the surface of the infiltration layer, which results in a higher magnesium content at the surface of the infiltration layer. However, this situation only appears on the surface of the infiltration layer. With the progress of the corrosion, the surface of the infiltration layer with high magnesium content will be corroded, and the infiltration layer with a magnesium content of 0.5 wt %-20 wt % that can prevent metal parts from being corroded would be exposed. In this infiltration layer, magnesium will accumulate at the weak grain boundaries of zinc and form zinc-magnesium alloy phases such as MgZn₂ and Mg₂Zn₁₁ through high-temperature reactions. The alloy phases such as MgZn₂ and Mg₂Zn₁₁ have high corrosion-resistance, and therefore, the formation of these phases at the grain boundaries can promote the original weak grain boundary structure to become a strong grain boundary structure. Especially, such strong grain boundary structure is not transparent to corrosive substances such as chloride ions, and thus can block these corrosive substances. Meanwhile, during the corrosion process of zinc-magnesium alloy phases such as MgZn₂, Mg₂Zn₁₁, the corrosion products caused thereby have a dense structure, rather than the loose structure caused by ordinary powder sherardizing, which greatly improves the corrosion resistance of the metal part and greatly extends the service life of the metal part.

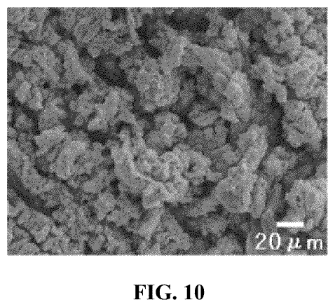

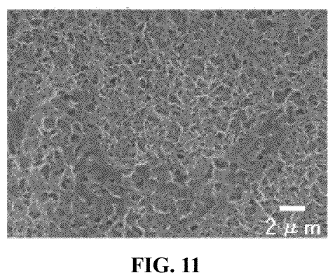

Referring to FIG. 10 and FIG. 11, FIG. 10 is an enlarged view of corrosion products on the surface of common sherardized layer, and FIG. 11 is an enlarged view of corrosion products on the surface of a magnesium-containing sherardized layer of an anti-corrosion metal part provided by this example. It can be seen that corrosion products produced on the surface of common sherardized layer is far more than corrosion products produced on the surface of the magnesium-containing sherardized layer of the anti-corrosion metal part provided in this example. In other words, the anti-corrosion metal part provided in this example has a significant improvement in its corrosion resistance due to its sherardized layer containing a certain amount of magnesium.

### EXAMPLE 5

This example provides a sherardizing method, including S1 to S3.

At S1, a metal part to be sherardized is treated by degreasing and derusting, and the treated metal part and the powder sherardizing agent described in Example 1 or 2 are placed in a closed infiltration tank.

At S2, air is driven out from the closed infiltration tank, and a valve of the closed infiltration tank is closed.

In the practices, the closed infiltration tank can be evacuated, or a protective atmosphere can be introduced into the closed infiltration tank to drive out the air from the closed infiltration tank, and close the valve of the closed infiltration tank. The protective atmosphere is preferably an inert gas.

At S3, the temperature of the closed infiltration tank is raised, and after reaching a preset temperature, the temperature is kept for 1-10 hours to complete the sherardizing.

In the practices, the closed infiltration tank can be heated, and the temperature can be increased to 360° C.-415° C. or 320° C.-480° C. for 1-10 hours, such as 2 hours, 4 hours, 6 hours, 8 hours, or the like, so as to complete the sherardizing. When the powder sherardizing agent is a static powder, the preset temperature is preferably 360° C.-415° C., such as 360° C., 370° C., 380° C., 390° C., 400° C., 410° C., 415° C. or the like. When the powder sherardizing agent is a dynamic powder, the preset temperature is preferably 320° C.-480° C., such as 320° C., 340° C., 360° C., 380° C., 400° C., 420° C., 440° C., 460° C., 480° C. or the like.

The sherardizing method provided in this example can effectively prevent the magnesium of the powder sherardizing agent from reacting with air by driving out the air in the closed infiltration tank. In addition, by raising the temperature of the closed infiltration tank, not only the air in the closed infiltration tank is further driven away, but also suitable environmental conditions are created to complete the sherardizing of the metal part. After the temperature is raised to the preset temperature, the temperature is kept for 1-10 hours to complete the sherardizing. Through this method, the sherardizing achieves good effects, and the infiltration layer has high quality. The sherardizing method provided by the disclosure has advantages including simple operation, convenient use, low cost, high economic benefit, and wide application range.

### EXAMPLE 6

The powder sherardizing agent and sherardizing method provided in the disclosure have brought out significant improvements in many aspects of its application. Here, lightning protection, railway fasteners, and high-strength fasteners are taken as examples for descriptions in details

First, regarding the lightning protection, electroplated copper is usually used in the current anti-corrosion method for the lightning protection. On the one hand, the cost of electroplated copper is very high. Currently, the electroplated copper of grounding part requires more than 20,000 ¥/Ton in processing fees. On the other hand, in environments such as alkaline soils, copper is prone to be corroded, which can easily lead to premature corrosion and failure of the grounding part. Meanwhile, it can also cause heavy metal pollution to the environment such as soil and water sources. At present, the corrosion resistance of pure electro-galvanized, hot-dip galvanized, or powder zinc infiltration products cannot meet the requirements of grounding standards. To meet the requirements of corrosion resistance, they must be subjected with treatments such as sealing treatment. However, once treatments such as sealing treatment are done, conductivity of the grounding part will decrease significantly, failing to meet the electrical conductivity requirements for lightning protection and grounding.

The above-mentioned problems can be perfectly solved by using the powder sherardizing agent and the sherardizing method provided in this disclosure. Since the magnesium powder is added to the powder sherardizing agent, the corrosion resistance of the sherardized metal part will be greatly improved. In addition, the corrosion resistance performance and service life can meet the standard requirements without sealing and other treatments. Furthermore, zinc and magnesium will not cause any pollution to the ecological environment. Meanwhile, the total cost of the powder sherardizing agent and the sherardizing method provided by this disclosure is less than 5,000 ¥/Ton, which can greatly reduce the overall cost of the lightning protection industry.

Second, regarding railway fasteners, railway fasteners are generally subjected with sherardizing by using the combination of powder sherardizing and sealing treatment. However, under the high vibration environment of the railway, the actual service life of the fastener is far from the design requirements. The railway fasteners were often replaced as a whole before the actual service life has reached half of the design life.

Using the powder sherardizing agent and sherardizing method provided in the present disclosure, by infiltrating a proper amount of magnesium into the infiltration layer of railway fasteners, the corrosion resistance thereof can be greatly improved, and the service life can be greatly prolonged, which can fully meet the high requirements of special application including subways.

Salt spray test and sulfur dioxide corrosion test are performed on railway gaskets through using the powder sherardizing agent and sherardizing method described in this disclosure by Fujian Guokeng Railway Engineering Equipment Co., Ltd. on October 2019. The test results show that the service life of the railway gasket after sherardizing treatment with the powder sherardizing agent by the sherardizing method of the present disclosure, reaches more than 2000 hours and 1000 hours in the sand blowing and salt spray. The existing powder sherardizing subsequent sealing, dacromet and other treatments are required to use inorganic and organic coatings. Under simulated sandstorm conditions, they will usually be blown off quickly and directly, and the sherardizing layer will be exposed. Therefore, the salt spray resistance life of common sherardizing layer is often tens of hours. Especially, since the design life of subways and railways requires more than 100 years, this technology has excellent application prospects.

A neutral salt spray test (NSS test) on subway and railway gaskets by using the powder sherardizing agent and sherardizing method described in this disclosure is conducted by Mechanical Industry Surface Covering Product Quality Supervision and Inspection Center (Surface Engineering Laboratory of Wuhan Material Protection Research Institute Co., Ltd.) on December 2019. The test results showed that no red rust appears on the surface of the subway and railway gaskets that were sherardized by the method described in this example after 1500 hours of neutral salt spray test.

This is enough to show that the powder sherardizing agent and sherardizing method provided in this disclosure can fully realize the preparation of the high corrosion-resistant sherardizing layer of metal part used in railways. After sherardizing, the neutral salt spray life of the metal parts can reach more than 1500 hours. Meanwhile, subsequent sealing, dacromet and other coating treatments can be omitted, which not only simplifies the process, but also greatly improves the performance of the metal part.

Third, regarding high-strength fasteners and taking the wind power industry as an example, wind power bolts in the wind power industry are high-strength fasteners. Currently, the combination of powder sherardizing with sealing treatment or dacromet treatment is used. In addition, the follow-up maintenance basically depends on brush painting. Once installed, wind power bolts are difficult to be replaced. Once they break and fail due to corrosion, it will cause great property losses and even casualties.

Using the powder sherardizing agent and the sherardizing method provided in this disclosure will not cause the above-mentioned problems. Magnesium is introduced into the infiltration layer, and corrosion-resistant alloy phases such as MgZn₂ and Mg₂Zn₁₁ are formed during thermal diffusion. During the corrosion process of the infiltration layer, the magnesium-zinc alloy phase promotes the generation of dense and insoluble corrosion products. Meanwhile, MgZn₂ and other alloys have a dense structure, which effectively reduces the corrosion rate. When the surface of the infiltration layer is scratched, a dense compound layer can be quickly formed on the damaged part to prevent further corrosion. Therefore, fasteners having a self-repairing function and suitable for high-strength application can be obtained.

### EXAMPLE 7

Test groups 1-4 are provided in this example. The metal parts used in test groups 1-4 are the same. In test group 1, the metal part is subjected with electro-galvanizing treatment. In test group 2, the metal part is subjected with hot-dip galvanizing treatment. In test group 3, the metal part is subjected with powder galvanizing and sealing treatment. In test group 4, the metal part is subjected with the powder sherardizing agent described in Example 1 by the method described in Example 4. After these treatments, the hardness, corrosion resistance life, hydrogen embrittlement, salt spray resistance, the thickness of the infiltration layer, abrasion resistance, sulfur dioxide resistance and other properties of metal parts in each group are tested, and the results are shown in Table 1.

TABLE 1
Comparison of performances of metal parts in each group

| Performance | Test group 1 | | Test group 2 | | Test group 3 | | Test group 4 | |
|---|---|---|---|---|---|---|---|---|
| Hardness (HV) | 180-200 | | 180-200 | | 300-380 | | 300-400 | |
| Corrosion Resistance life | <1 | year | 5-10 | years | >20 | years | >50 | years |
| Hydrogen embrittlement | Yes | | Yes | | No | | No | |
| Salt spray test | <100 | h | >100 | h | 300-1000 | h | >1500 | h |
| Thickness of the | 5-30 | μm | 5-70 | μm | 20-120 | μm | 5-200 | μm |
| infiltration layer | | | | | | | | |

| | | | | |
|---|---|---|---|---|
| Tolerance influence | Small | Large | Small | Small |
| Abrasion resistance | General | General | Good | Good |
| Sulfur dioxide resistance | Poor | Poor | General | Good |
| Uniformity of appearance | Good | Poor | Good | Good |

It can be seen from the above data, by using the powder sherardizing agent through the sherardizing method provided in this disclosure on the metal part will bring out good effects including high hardness, long corrosion resistance life, no hydrogen embrittlement, anti-salt spray, and sulfur dioxide resistance. In addition, the powder sherardizing agent provided by this disclosure will not cause any pollution to the environment, and thus can be built and manufactured in urban areas, which has a broad prospect.

### EXAMPLE 8

The powder sherardizing agent of this example includes the following components: 35 parts of zinc powder with a particle size of 10 μm, 10 parts of magnesium powder with a particle size of 20 μm, 50 parts of alumina powder with a particle size of 50 μm, and 5 parts of ammonium chloride.

The above components according to the above ratio are weighted at the corresponding weight parts and put into the rotary sherardizing furnace (rotating speed, 15 rpm) together with 45 # round steel (4000 parts by weight). When the temperature is raised to 300° C., the ammonium chloride begins to decompose and a large amount of gas is generated. When the temperature reaches 350° C., the valve of the sherardizing furnace is closed to make it in a low-oxygen sealed state. After keeping at 400° C. for 6 hours, a magnesium-containing sherardized layer is obtained. The thickness of the infiltration layer is 55 μm, and the neutral salt spray resistance time is 400 hours (Upon the 400-hour neutral salt spray test, no red rust appeared on the surface of the sample).

In view of the above, zinc and magnesium can form a zinc-magnesium alloy phase with high corrosion resistance, which can greatly improve the corrosion resistance of the infiltration layer.

### EXAMPLE 9

The powder sherardizing agent of this example includes the following components: 32 parts of zinc powder with a particle size of 10 μm, 5 parts of AZ91 magnesium alloy powder with a particle size of 30 μm, 60 parts of alumina powder with a particle size of 50 μm, 2 parts of ammonium chloride, and 1 part of magnesium chloride.

The above components according to the above ratio are weighted at the corresponding weight parts and put into the rotary sherardizing furnace together with Q235 lightning protection grounding rod (3000 parts by weight). A vacuum is established until the vacuum degree reaches within 1000 Pa. The value of the sherardizing tank is closed to make it in a low-oxygen sealed state. After keeping at 410° C. for 6 hours, a magnesium-containing sherardized layer is obtained. The thickness of the infiltration layer is 62 μm, and the neutral salt spray resistance time is 1000 hours (Upon the 1000-hour neutral salt spray test, no red rust appeared on the surface of the sample).

In view of the above, when both magnesium powder and magnesium halide activator are added to the powder sherardizing agent, the magnesium halide activator can promote the rapid and effective infiltration of magnesium into the infiltration layer, thereby further improving the corrosion resistance of the infiltration layer.

### EXAMPLE 10

The powder sherardizing agent of this example includes the following components: 32 parts of zinc powder with a particle size of 5 μm, 15 parts of AZ31 magnesium alloy powder with a particle size of 20 μm, 50 parts of alumina powder with a particle size of 20 μm, 2 parts of ammonium chloride, and 1 part of magnesium chloride.

The above components according to the above ratio are weighted at the corresponding weight parts and put into the rotary sherardizing furnace (rotating speed, 20 rpm) together with Q235 lightning protection grounding rod (3000 parts by weight). A vacuum is established until the vacuum degree reaches within 1000 Pa. The value of the sherardizing tank is closed to make it in a low-oxygen sealed state. After keeping at 410° C. for 6 hours, a magnesium-containing sherardized layer is obtained. The thickness of the infiltration layer is 62 μm, and the neutral salt spray resistance time is 1600 hours (Upon the 1600-hour neutral salt spray test, no red rust appeared on the surface of the sample).

In view of the above, when both magnesium powder and magnesium halide activator are added to the powder sherardizing agent, the magnesium halide activator can promote the rapid and effective infiltration of magnesium into the infiltration layer, thereby further improving the corrosion resistance of the infiltration layer.

### EXAMPLE 11

The powder sherardizing agent of this example includes the following components: 38 parts of zinc powder with a particle size of 5 μm, 5 parts of self-made magnesium powder with a particle size of 10 μm, 55 parts of alumina powder with a particle size of 20 μm, 1 part of ammonium chloride, and 1 part of magnesium chloride. The self-made magnesium powder includes in weight percentage, 80% magnesium, 15% aluminum, and 5% zinc.

The above powder and the active agent according to the a above ratio are weighted at the corresponding weight parts and put into the rotary sherardizing furnace (rotating speed, 30 rpm) together with 60 Si₂Mn railway gaskets (5000 parts by weight). Argon is introduced. After argon is introduced to the infiltration tank to drive away air, the temperature is raised. Argon is continuously introduced during the temperature rise, keeping, and dropping, to ensure that the whole process is in a protective atmosphere. After keeping at 415° C. for 8 hours, a magnesium-containing sherardized layer is obtained. The thickness of the infiltration layer is 80 μm, and the neutral salt spray resistance time is 2000 hours (Upon the 2000-hour neutral salt spray test, no red rust appeared on the surface of the sample).

In view of the above, when both magnesium powder and magnesium halide activator are added to the powder sherardizing agent, the magnesium halide activator can promote the rapid and effective infiltration of magnesium into the infiltration layer, thereby further improving the corrosion resistance of the infiltration layer.

### EXAMPLE 12

The powder sherardizing agent of this example includes the following components: 44 parts of zinc powder with a particle size of 1 μm, 14 parts of AZ91 magnesium alloy powder with a particle size of 5 μm, 40 parts of silicon oxide powder with a particle size of 10 μm, and 2 parts of magnesium chloride.

The above powder and the active agent according to the a above ratio are weighted at the corresponding weight parts and put into the static sherardizing furnace (rotating speed, 0 rpm, ensuring that there will be no collision and deformation between precision parts) together with 40CrMo steel mold (1000 parts by weight). A vacuum is established until the vacuum degree reaches within 100 Pa. The value of the sherardizing tank is closed to make it in vacuum. The temperature is kept at 385° C. for 8 hours during which a magnesium-containing sherardized layer is obtained. The thickness of the infiltration layer is 40 μm, and the neutral salt spray resistance time is 1000 hours (Upon the 1000-hour neutral salt spray test, no red rust appeared on the surface of the sample).

In view of the above, when both magnesium powder and magnesium halide activator are added to the powder sherardizing agent, the magnesium halide activator can promote the rapid and effective infiltration of magnesium into the infiltration layer, thereby further improving the corrosion resistance of the infiltration layer.

### EXAMPLE 13

In this example, a test group and a control group are provided. Table 2 shows the composition of the powder sherardizing agent of each group.

TABLE 2
Composition of the powder sherardizing agent of each group

| Group | Composition of the powder sherardizing agent |
|---|---|
| Test group | Zinc powder 40 parts + magnesium powder 8 parts + |
| | alumina powder 50 parts + ammonium chloride 1 part + |
| | magnesium chloride 1 part |
| Control group | Zinc powder 40 parts + aluminum powder 8 parts + |
| | alumina powder 50 parts + ammonium chloride 1 part + |
| | magnesium chloride 1 part |

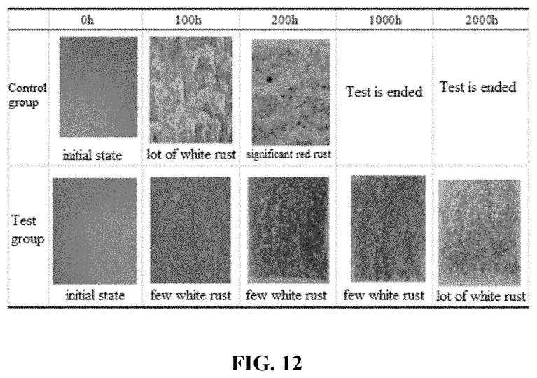

The powder sherardizing agents of the test group and the control group and the sherardizing method described in Example 5 are used to perform sherardizing treatment on the metal part. In addition, a salt spray test is carried out. The results are shown in FIG. 12.

Referring to FIG. 12, it shows that the metal parts of the test group and the control group are in the initial state without any rust when the salt spray test is carried out for 0 h; a lot of white rust appears on the metal part of the control group, while only a few of white rust appears on the metal part of the test group, when the salt spray test is carried out for 100 h; significant red rust appears on the metal part of the control group, and the control test is ended, while only a few of white rust appears on the metal part of the test group, when the salt spray test is carried out for 200 h; there is still only a few of white rust appears on the metal part of the test group, when the salt spray test is carried out for 1000 h; the white rust on the metal parts of the test group increases, when the salt spray test is performed for 2000 h.

In view of the above, in the salt spray test, the time for the metal part of the control group to appear red rust is much shorter than the time for the metal part of the test group to appear red rust. The test results of the control group are far inferior to the test results of the test group, so the powder sherardizing agent composed of components such as zinc powder, aluminum powder is used for the sherardizing treatment of the metal part. The formed zinc-aluminum infiltration layer has very limited improvement in corrosion resistance. However, when the metal part is sherardized by the powder sherardizing agent provided in this example, the corrosion resistance of the infiltration layer can be significantly improved, and the service life of the metal part can be significantly extended.

### EXAMPLE 14

In this example, test groups 1-4 are provided. Table 3 shows the composition of the powder sherardizing agent of each group.

TABLE 3
Composition of the powder sherardizing agent of each group

| Group | Composition of the powder sherardizing agent |
|---|---|
| Test group 1 | Zinc powder 48 parts + alumina powder 50 parts + |
| | ammonium chloride 2 parts |
| Test group 2 | Zinc powder 40 parts + magnesium powder 8 parts + |
| | alumina powder 50 parts + ammonium chloride 2 parts |
| Test group 3 | Zinc powder 40 parts + magnesium powder 8 parts + |
| | alumina powder 50 parts + ammonium chloride |
| | 0.8 parts + magnesium fluoride 1 part + manganese |
| | dioxide 0.2 parts |
| Test group 4 | Zinc powder 180 parts + aluminum powder 4 parts + |
| | magnesium powder 2 parts + cobalt powder 1.5 parts + |
| | lead powder 0.8 parts + aluminum stearate powder |
| | 1.2 parts + magnesium sulfate 1 part + ammonium |
| | chloride 2 parts |

The powder sherardizing agents of test groups 1-4 and the sherardizing method described in Example 5 are used to perform sherardizing treatment on metal parts. In addition, a salt spray test is performed. The results are shown in Table 4.

TABLE 4
Comparison of salt spray test results of
powder sherardizing agent of each group

| Group | 100 h | 200 h | 500 h | 1000 h | 2000 h | 3000 h | 3500 h |
|---|---|---|---|---|---|---|---|
| Test | lot of | Signifi- | Test is | Test is | Test is | Test is | Test is |
| group 1 | white | cant red | ended | ended | ended | ended | ended |
| | rust | rust | | | | | |
| Test | few | few | few | few | few | few | lot of |
| group 2 | white | white | white | white | white | white | white |
| | rust | rust | rust | rust | rust | rust | rust |
| Test | few | few | few | few | few | few | lot of |
| group 3 | white | white | white | white | white | white | white |
| | rust | rust | rust | rust | rust | rust | rust |
| Test | lot of | Signifi- | Test is | Test is | Test is | Test is | Test is |
| group 4 | white | cant red | ended | ended | ended | ended | ended |
| | rust | rust | | | | | |

In view of the above, after the powder sherardizing agent of test group 1 is used for the sherardizing treatment of the metal part, a lot of white rust appears on the metal parts with infiltration layer when the salt spray test is carried out for 100 h. and obvious red rust appears when the salt spray test is carried out for 200 h. The powder sherardizing agents of test group 2 and test group 3, i.e., the powder sherardizing agent provided by the present disclosure, are used for performing the sherardizing treatment on the metal parts, the metal parts with the forming zinc-magnesium infiltration layer appear a few of white rust only when the salt spray test is carried out for 100 h-3000 h, and appear a lot of white rust when the salt spray test is carried out for 3500 h. Therefore, the corrosion resistance of the metal part is significantly improved. After the powder sherardizing agent of test group 4 is used to sherardize the metal part, a lot of white rust appears on the metal part with the forming infiltration layer when the salt spray test is carried out for 100 h, and significantly red rust appears when the salt spray test is carried out for 200 h, which is similar as that of the test group 1. It can be seen that adding too many components to the powder sherardizing agent in the test group 4 does not improve the corrosion resistance.

This is because the powder sherardizing involves a solid-solid reaction, and the infiltration layer is formed by solid phase diffusion. It is easy to achieve the powder sherardizing via a single element, while multi-element co-infiltration is not so. When the elements contained in the powder sherardizing agent form chemical compounds at a high diffusion temperature or intermetallic compounds with a small solid solubility, the activity of the penetrating agent is significantly reduced. In a dual infiltrating agent, as the concentration of one element increases, the activity of the other element's atoms will be reduced. However, when the ratio of the two infiltrating elements in the penetrating agent exactly matches the composition ratio of the chemical compound, the infiltration layer cannot be formed via diffusion. If the amount of one of the infiltrating elements of the powder sherardizing agent is more than the amount required to form the compound, only the infiltration of that element will occur. For the co-infiltration of multi-element alloys above ternary element, the mechanism is more complicated. Therefore, for powder sherardizing, the simplest component and the simplest catalyst are used to form a specific infiltration layer, which has engineering application value.

Referring to the test group 4, the powder zinc infiltration agent provided by this group contains zinc powder, magnesium powder, aluminum powder and other metal powders. Taking zinc powder, magnesium powder and aluminum powder as examples, aluminum is more active than zinc. Therefore, magnesium reacts with aluminum first. Once magnesium reacts with aluminum, a stable magnesium-aluminum compound will be formed. The magnesium-aluminum compound having stable performances cannot infiltrate into the sherardizing layer because it cannot provide the chemical driving force required for diffusion. Therefore, when magnesium and aluminum are added to the powder sherardizing agent, the content of magnesium should higher than that of aluminum to infiltrate magnesium into the sherardizing layer. The content of magnesium can be 7 wt %, etc., to provide a sufficient amount of active magnesium atoms to diffuse into the sherardized layer. If there are other alloying elements in addition to magnesium and aluminum in the sherardizing agent, it is usually required to further increase the content of magnesium to promote the diffusion of magnesium into the sherardizing layer. In addition, in the infiltration layer that is mainly composed of zinc-aluminum alloy, a certain amount of magnesium is added to the powder sherardizing agent. Magnesium can at a certain extent, infiltrate into the structure of the infiltration layer. However, due to the presence of aluminum in the sherardized layer, magnesium will also preferentially react with aluminum and form a magnesium-aluminum alloy phase structure in the infiltration layer. Although the magnesium-aluminum alloy phase can refine the grains of the infiltration layer structure, it cannot improve the corrosion resistance thereof. Since magnesium preferentially reacts with aluminum in the infiltration layer, magnesium basically can no longer react with zinc in the infiltration layer to form zinc-magnesium alloy phases with high corrosion resistance such as MgZn₂, Mg₂Zn₁₁, and cannot improve the corrosion resistance of the infiltration layer. In this disclosure, the terms “upper”, “lower”, “front”, “back”, “left”, “right”, and the like are merely intended to indicate the relative positional relationship between related parts, but not to limit the absolute position of these related parts.

In this disclosure, the terms “first”, “second” and the like are merely intended to distinguish features from each other, rather than indicating the importance degree, sequence, and the premise of mutual existence of these features.

In this disclosure, the words “equal”, “same” and the like are not strictly limited in terms of mathematics and/or geometry, and also include errors that can be understood by those skilled in the art and allowed for manufacturing or use.

Unless otherwise specified, the numerical range herein includes not only the whole range within endpoints, but also several sub-ranges included therein.

The preferred examples and embodiments of this application are described in detail above with reference to the accompanying drawings. However, the application is not limited to the above examples and embodiments. Various modifications may be made within the scope of the knowledge of those skilled in the art without departing from the spirit of the disclosure.

1. A powder sherardizing agent, comprising in parts by mass,
20-100 parts of a metal powder, 40-80 parts of a dispersing agent, and 0.2-5 parts of a decomposing agent,
wherein the metal powder comprises 60-97 parts of zinc powder and 3-40 parts of magnesium powder.

2. The powder sherardizing agent of claim 1, wherein the magnesium powder is pure magnesium powder or magnesium alloy powder;
preferably, the magnesium powder is the pure magnesium powder with purity greater than 95% or the magnesium alloy powder with a weight ratio of not less than 40% magnesium.

3. The powder sherardizing agent of claim 1, wherein the dispersing agent is ceramic powder, and the decomposing agent is ammonium halide,
preferably, the ceramic powder comprises at least one of aluminum oxide, silicon oxide, magnesium oxide, aluminum nitride, silicon nitride, and silicon carbide;
more preferably, the ammonium halide comprises at least one of ammonium chloride, ammonium fluoride, ammonium iodide, ammonium bromide, and ammonium hydrogen fluoride.

4. The powder sherardizing agent of claim 1, wherein the powder sherardizing agent further comprises 0.5-3 parts of an active agent capable of promoting infiltration of magnesium into an infiltration layer;
preferably, the active agent is a magnesium halide.

5. The powder sherardizing agent of claim 1, wherein the magnesium powder has a particle size of 10 μm-500 μm, the zinc powder has a particle size of 1 μm-200 μm, and the dispersing agent has a particle size of 5 μm-500 μm.

6. The powder sherardizing agent of claim 1, wherein the powder sherardizing agent further comprises manganese dioxide, and a mass part of manganese dioxide is not greater than a mass part of the decomposing agent.

7. An anti-corrosion metal part having an infiltration layer formed by a surface of the anti-corrosion metal part through magnesium and zinc infiltrated by the powder sherardizing agent of claim 1, and capable of preventing corrosion of the metal part.

8. The anti-corrosion metal part of claim 7, wherein the infiltration layer has an average content of magnesium of 0.5 wt %-20 wt %;
preferably, the infiltration layer has a thickness of 5 μm-200 μm.

9. A sherardizing method, comprising:
S1, treating a metal part to be sherardized with degreasing treatment and derusting treatment, and placing the treated metal part and the powder sherardizing agent of claim 1 in a closed infiltration tank;
S2, driving out air from the closed infiltration tank, and closing a valve of the closed infiltration tank;
S3, raising a temperature of the closed infiltration tank, and maintaining the temperature for 1-10 hours after reaching a preset temperature, to complete the sherardizing.

10. The sherardizing method of claim 9, wherein at S2, the closed infiltration tank is evacuated, or a protective atmosphere is introduced into the closed infiltration tank to drive out the air from the closed infiltration tank and close the valve of the closed infiltration tank,
at S3, the temperature of the closed infiltration tank is raised, and the temperature is raised to 360° C.-415° C. or 320° C.-480° C. for 1-10 hours to complete the sherardizing.
